(19) United States
(12) Patent Application Publication
(10) Pub. No.: US 2012/0331383 A1
(43) Pub. Date: Dec. 27, 2012

(54) Apparatus and Method for Input of Korean Characters

(76) Inventor: Choung Shik Park, Sunnyvale, CA (US)

(21) Appl. No.: 13/169,020

(22) Filed: Jun. 27, 2011

(51) Int. Cl. G06F 3/033

(52) U.S. Cl. 715/703

(57) ABSTRACT

A method is for input of Korean characters into an electronic device having a gesture input component. The method includes displaying a minimal set of consonant candidates for a starting or trailing consonant of a Korean character, and selecting character elements based on the gesture detected from a gesture input component. The starting of a gesture selects a consonant, and a vowel is selected or the initially selected consonant is altered as the gesture continues to one of the four basic directions: leftward, upward, rightward and downward. A Korean character is composed and outputted based on the selected consonant and vowel.

### BACKGROUND

1. Technical Field

The present invention relates to data input on electronic devices. More specifically, the present invention is directed to an apparatus and method for input of Korean characters.

2. State of the Art

In Korean writing system, Hangul, a character is composed of three elements: a starting consonant, a vowel and an optional trailing consonant. Starting and trailing consonants have 19 and 28 variants respectively. As a vowel has 21 variants, there are 11,172 possible combinations for a Korean character.

For electronic devices that need input of Korean characters, it is impractical to add a keyboard with 11,172 keys for each of the Korean character combinations, or instruct the user to choose a Korean character after displaying all its possible combinations. Hence electronic device developers commonly implement a method for composing a Korean character by choosing a variant for each of the Korean character elements. The electronic device then automatically composes a Korean character based on the selections.

Korean character composition methods commonly used on electronic devices are based on keys. Each key is assigned to a consonant or vowel of Korean character elements. Depending on the number of available keys, some keys may be assigned to more than one consonants or vowels. In such configuration where a key represents plurality of consonants or vowels, a user needs to use a modifier key such as shift key or function key, or press multiple keys in a certain sequence to select a desired consonant or vowel.

To improve user experience, electronic device developers are nowadays consolidating multiple hardware components by utilizing gesture input components such as touch-screens and 3-dimensional motion sensors. For example, a touch-screen is commonly used for removing keys and buttons on an electronic device as it provides enough information to mimic any key or button behavior.

Gesture input components are more than capable of providing functions for replacing keys and buttons. They also provide movement information relative to the operation of an electronic device. However, the Korean character composition methods commonly used on electronic devices do not make any use of the movement information readily available from such gesture input components.

### BRIEF SUMMARY

The present invention provides a method for input of Korean characters into an electronic device having a gesture input component. The method of the present invention utilizes any gesture input component that provides gesture data. The gesture data simply need to include starting and ending positions of a gesture as well as its movement coordinates.

The method of the present invention comprises the steps of displaying a minimal set of consonant candidates, acquiring gesture data from a gesture input component, selecting a consonant from the displayed consonant candidates based on the starting position of the gesture, selecting a vowel based on the direction and position of the gesture, composing a Korean character based on the selected consonant and vowel, and outputting a Korean character and/or a Jamo character.

The selected consonant is altered when the user continues the gesture leftward or upward after starting the gesture on a displayed consonant candidate. When the user continues the gesture rightward or downward after selecting a consonant, a vowel is selected from a set of vowel candidates associated with the gesture direction based on the horizontal or vertical distance from the selected consonant. When the orientation of the gesture direction is changed while selecting a vowel, a vowel is selected from a new set of vowel candidates assigned to the location where the orientation of the gesture direction is changed.

The displayed consonant candidates can be used for either starting or trailing consonant of a Korean character. However, the method of the present invention resolves the ambiguity between the usages as the user clearly finds a distinction while executing the method. If the user wants to use the selected consonant as a starting consonant, the user simply needs to continue the gesture and select a vowel; the selected consonant is then used as a starting consonant and forms a Korean character with the selected vowel. If the user wants to use the selected consonant to form a trailing consonant for the previously saved incomplete Korean character, the user only needs to stop the gesture without selecting a vowel.

In a preferred embodiment of the present invention, 2-dimensional gesture data are acquired from a touch-screen. A gesture begins when the user enters and touches the surface of the touch-screen, and ends when the user leaves the surface of the touch-screen.

In another preferred embodiment, the touch-screen may be replaced with a 3-dimensional motion sensor. In such embodiment, the starting and ending of a gesture can easily be determined by monitoring any one of the dimensional values of the movement coordinates reported by the 3-dimensional motion sensor.

Further features of the present invention will be described or will become apparent in the course of the following detailed description.

### BRIEF DESCRIPTION OF THE DRAWINGS

FIG. 1A shows an example of a Korean character composed of a starting consonant, a vowel and a trailing consonant.

FIG. 1B shows an example of a Korean character composed of a starting consonant and a vowel.

FIG. 1C shows an example of another Korean character composed of a starting consonant, a vowel and a trailing consonant.

FIG. 2 is a block diagram of a system of inputting Korean characters.

FIG. 3 is a flow chart illustrating a method of composing a Korean character according to the present invention.

FIG. 4 shows a placement of the consonants of Consonant Candidate Set on a QWERTY keyboard.

FIG. 5 shows the QWERTY keyboard of FIG. 4 when its shift key is pressed.

FIG. 6 shows a placement of the consonants of Consonant Candidate Set on a telephone keypad.

FIG. 7 is a flow chart illustrating the process of handling received gesture data.

FIG. 8 shows consonant candidates associated with gesture directions.

FIG. 9 illustrates an example of a displayed consonant candidate and its association with horizontal gesture directions.

FIG. 10 illustrates an example of a displayed consonant candidate and its association with vertical gesture directions.

FIG. 11 shows a placement of the vowels of 1st Vowel Candidate Set.

FIG. 12 shows a placement of the vowels of 2nd Vowel Candidate Set.

FIG. 13 is a flow chart illustrating the process of handling change of orientation in gesture directions.

FIG. 14 shows vowel candidates assigned to the vowels of 1st and 2nd Vowel Candidate Sets.

FIG. 15 shows a placement of vowel candidates assigned to [symbol] .

FIG. 16 shows a placement of vowel candidates assigned to [symbol] .

FIG. 17 shows a placement of vowel candidates assigned to [symbol] .

FIG. 18 shows a placement of vowel candidates assigned to —.

FIG. 19 shows a placement of vowel candidates assigned to [symbol] .

FIG. 20 illustrates the steps for composing a Korean character [symbol] .

FIG. 21 illustrates the steps for composing a Korean character [symbol] .

FIG. 22 is a flow chart illustrating the process of handling character elements acquired from a gesture.

FIG. 23 shows examples of character elements acquired from a gesture and their character output results.

### DETAILED DESCRIPTION

A Korean character is composed of three elements: a starting consonant, a vowel and an optional trailing consonant. The starting and trailing consonants have a different set of variants. However, they are always one of the basic consonants or a combination of the basic consonants. The basic consonants comprise [symbol] [symbol] [symbol] and [symbol] .

The three elements of a Korean character are never used alone in a sentence unless the context of the sentence requires the elements to be named separately. In such case, the elements are commonly referred to as “Jamo” characters and they are treated as visual symbol characters rather than sound representing Korean characters.

Korean character composition mechanism is very unique as other phonetic writing systems commonly assign sounds of the language directly to their alphabet characters, and each of the characters is itself a consonant or vowel.

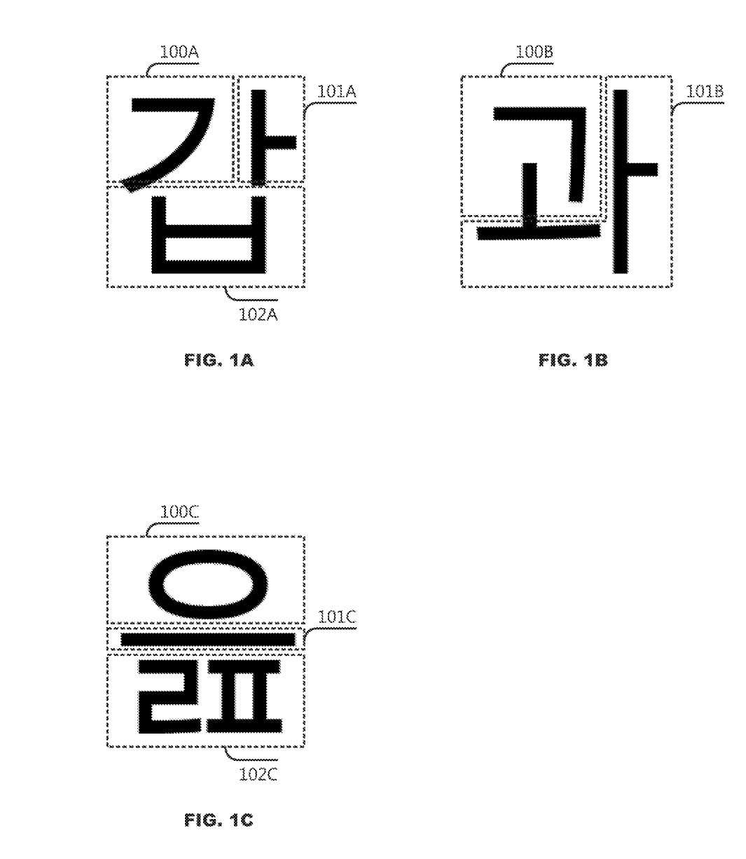

FIG. 1A shows a Korean character [symbol] (Unicode 0xAC11) composed of a starting consonant [symbol] 100A (Jamo character, Unicode 0x1100), a vowel [symbol] 101A (Jamo character, Unicode 0x1161) and a trailing consonant [symbol] 102A (Jamo character, Unicode 0x1107).

FIG. 1B shows a Korean character [symbol] (Unicode 0xACFC) composed of a starting consonant [symbol] 100B (Jamo character, Unicode 0x1100) and a vowel [symbol] 101B (Jamo character, Unicode 0x116A). In this example, the Korean character does not include a trailing consonant.

FIG. 1C shows a Korean character [symbol] (Unicode 0xC74A) composed of a starting consonant ∘ 100C (Jamo character, Unicode 0x110B), a vowel — 101C (Jamo character, Unicode 0x1173) and a trailing consonant [symbol] 102C (Jamo character, Unicode 0x11B5). The trailing consonant [symbol] 102C is a combination of [symbol] (Jamo character, Unicode 0x1105) and [symbol] (Jamo character, Unicode 0x1111) basic consonants.

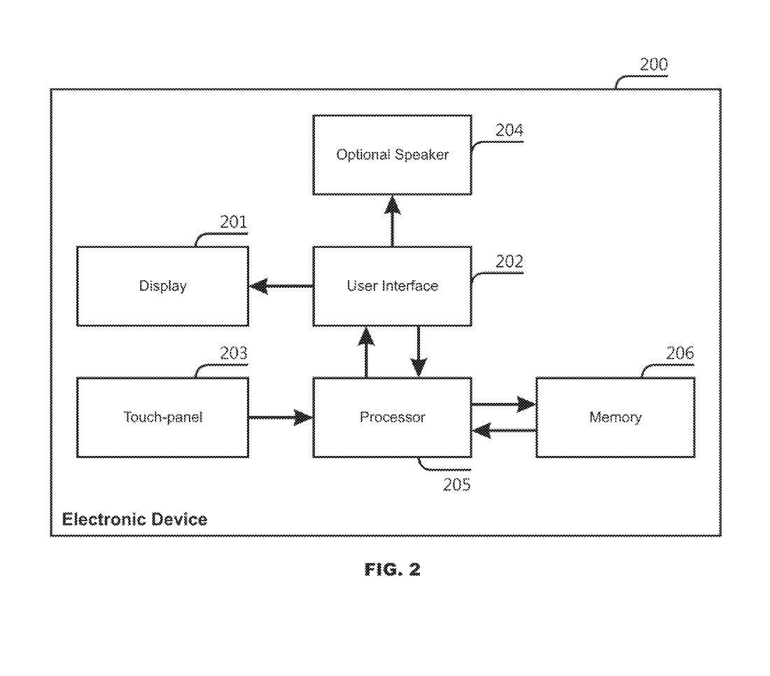

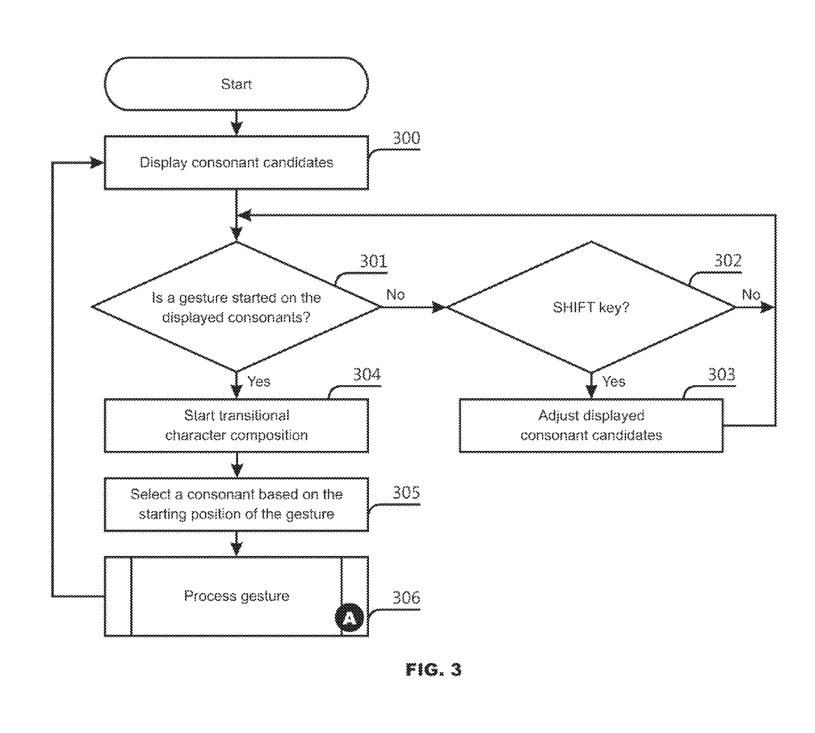

FIG. 2 shows a simplified block diagram of the hardware components of an electronic device 200 in which the present invention is implemented.

The user interface 202 provides information to the user of the electronic device 200 through the display 201 about the locations of consonant candidates where a gesture starts or updates composing of a Korean character. The user interface 202 also shows various states of pending Korean character composition and completed Korean characters on the display 201.

Optionally, the speaker 204 is also coupled to the user interface 202 for providing auditory feedback of pending character composition. The present invention selects a consonant and a vowel using a continuous gesture movement, thus such auditory feedback may improve the accuracy of the selections as the user can use the auditory feedback as guidance.

The touch-panel 203 acquires gesture data generated by the user. A gesture begins when the user enters and touches the surface of the touch-panel 203, and ends when the user leaves the surface of the touch-panel 203. The gesture data includes the movement coordinates of the gesture.

In another preferred embodiment, the touch-panel 203 may be replaced with an external 2-dimensional motion detection device such as the computer mouse commonly found with personal computers. In such embodiment where a computer mouse or similar type of device is used, the starting and ending of a gesture is determined by the state of the button attached to the device; a gesture begins when the user presses and holds the button, and ends when the button is released.

In yet another preferred embodiment, the touch-panel 203 may be replaced with a 3-dimensional motion sensor. In such embodiment, the starting and ending of a gesture can easily be determined by monitoring any one of the dimensional values of the movement coordinates reported by the 3-dimensional motion sensor.

The processor 205 receives gesture data from the touch-panel 203, and identifies positions and directions of the gesture. The processor 205 also selects character elements from the identified information, and composes a Korean character. The memory 206 holds transitional Korean character composition states.

The touch-panel 203 is often combined with the display 201 in portable electronic devices. For example, the touch-screen commonly used on smartphones and handheld portable computers (often called “personal data assistance” or PDA) displays information as well as detects the presence and location of a touch within the touch-screen.

The electronic device 200 may also be a programmable machine and all the components shown in FIG. 2 may be governed by operating system software. In such electronic device, the present invention is preferably implemented as a computer program for providing a Korean character input function to other programs and systems on the device.

FIG. 3 is a flow chart describing the basic process of the present invention in a preferred embodiment. A Korean character composition starts at step 300 where the consonants of Consonant Candidate Set are displayed. The Consonant Candidate Set comprises [symbol] [symbol] and [symbol] , and it is used for both selecting a starting consonant and forming a trailing consonant, as further described below.

In step 301, if a gesture is started on one of the displayed consonant candidates, step 304 is executed; otherwise step 302 is executed.

In step 302, the processing logic checks if the gesture is for invoking a shift key state. A shift key is commonly used for selecting an alternate character assigned to a key. For example, on an English alphabet keyboard, a user commonly uses a shift key to input capital letters.

The method of the present invention does not require a separate shift key to select a consonant that is not initially displayed; the selection of a consonant is changed according to the direction of the gesture. However, providing a separate shift key may help the user more easily locate and select a consonant without complicating underlying implementation of the present invention.

In step 303, if a shift key is confirmed in step 302, the displayed consonant candidates are changed to show the consonants of Consonant Candidate Set associated with upward gesture direction. If the displayed consonant candidates are already changed to the direction associated ones, they are changed back to the initially displayed consonant candidates.

In step 304, the processing logic recognizes a gesture started on one of the displayed consonant candidates, and marks the start of a transitional Korean character composition. The Korean character composition started in step 304 is considered transitional since the character elements acquired from this composition are used for updating the trailing consonant of the previously saved incomplete Korean character, or starting a new Korean character composition.

In step 305, a consonant is selected based on the starting position of the gesture. Additional processing of the gesture is handled in step 306 for changing the selected consonant and choosing a vowel, as further described below.

FIG. 4 shows the placement of the consonants of Consonant Candidate Set on a QWERTY keyboard of a preferred embodiment. The elements of Consonant Candidate Set, [symbol] [symbol] and [symbol] , are placed on W, E, R, T, A, S, D, F and G keys, respectively. The area where the keys are located is denoted as 401. The QWERTY keyboard shown in FIG. 4 has a shift key 402, and a dedicated key 403 for switching between English and Korean input modes.

A QWERTY keyboard has at least 28 keys; 26 keys for each of the alphabets, a shift key for inputting capital letters, and a space key for inputting a space character. As the preferred embodiment of the present invention only requires 9 distinct positions for a gesture to start a Korean character composition, other unused key positions may be used for entering symbols and other characters, or providing text editing functions. The unused key positions may also be used for displaying additional consonant candidates associated with leftward or upward gesture direction of the displayed consonant candidates. In such layout, the number gesture steps needed to compose a Korean character is reduced.

FIG. 5 shows the displayed consonant candidates when the shift key 402 in FIG. 4 is pressed. When the shift key 402 is pressed, the preferred embodiment shows the consonant candidates associated with upward gesture direction for the initially displayed consonant candidates. If the initially displayed consonant candidate does not have a consonant candidate associated with upward gesture direction, it remains the same. Therefore, [symbol] and [symbol] are changed to [symbol] and [symbol] , respectively. The area where the keys are located is denoted as 501.

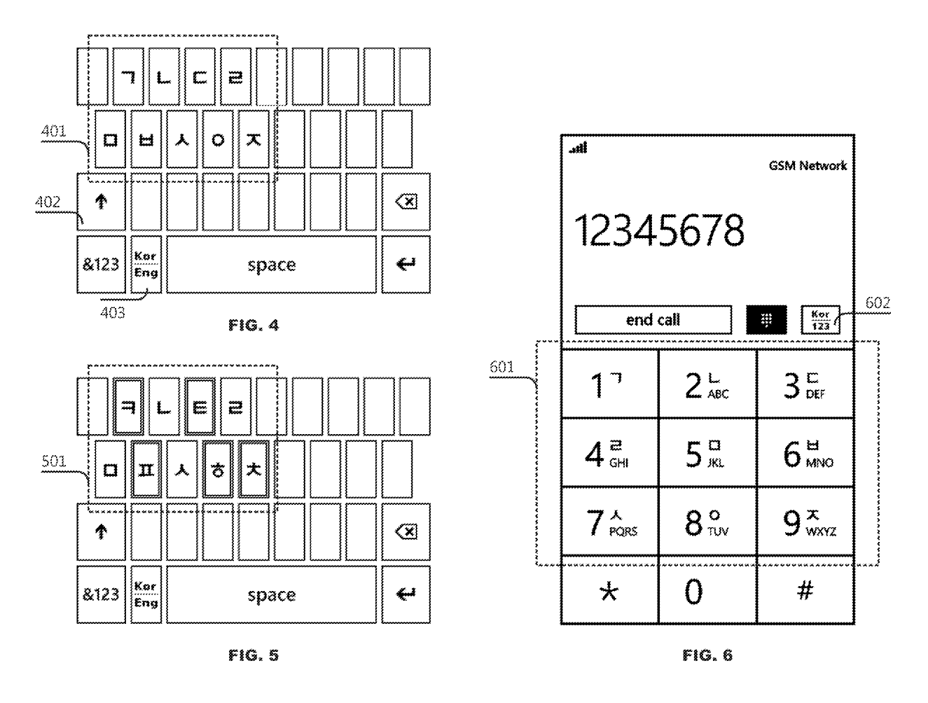

FIG. 6 shows the placement of the consonants of Consonant Candidate Set on a telephone keypad of another preferred embodiment. The elements of Consonant Candidate Set, [symbol] [symbol] and [symbol] , are placed on 1, 2, 3, 4, 5, 6, 7, 8 and 9 keys, respectively. The area where the keys are located is denoted as 601. The keypad shown in FIG. 6 has a dedicated key 602 for switching between number and Korean input modes.

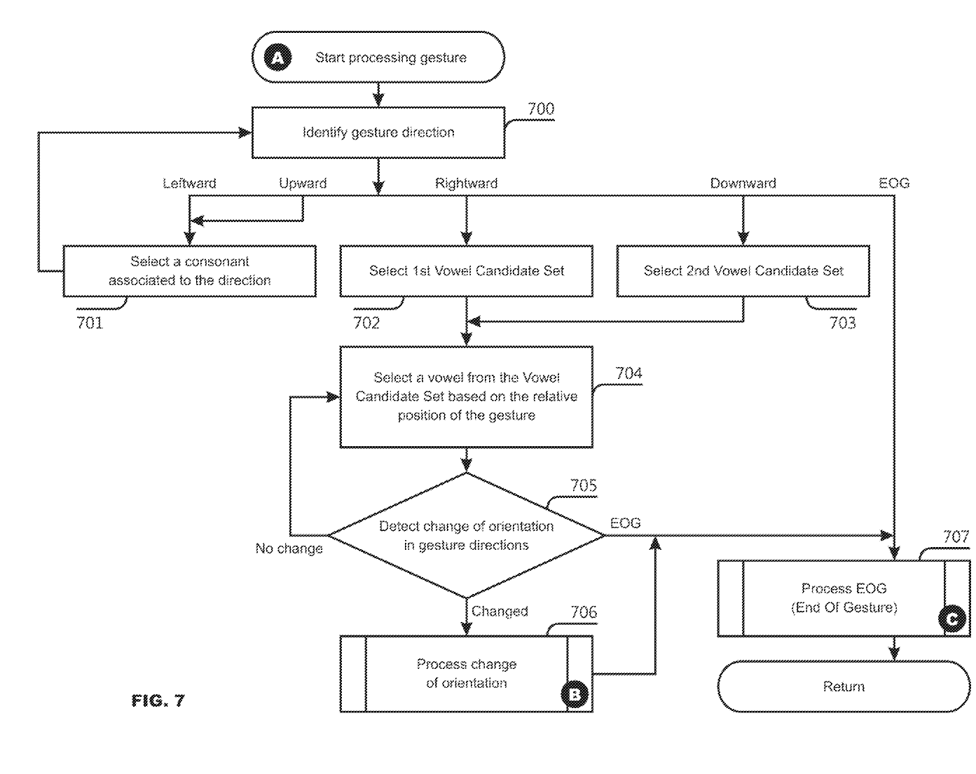

FIG. 7 is a flow chart describing the process of handling the received gesture data for composing a Korean character as illustrated as step 306 in FIG. 3.

The process starts with identifying the direction of the gesture in step 700. The present invention always identifies movements in a gesture as one of the four basic directions; leftward, upward, rightward and downward.

In step 700, the leftward and upward gesture directions are used for changing the selected consonant to its direction associated consonant candidate. The change of the selected consonant is handled in step 701.

In step 701 of a preferred embodiment, if the selected consonant is [symbol] , the leftward gesture direction changes it to [symbol] , and the upward gesture direction changes it to [symbol] ; if the selected consonant is [symbol] , the leftward gesture direction changes it to [symbol] , and the upward gesture direction changes it to [symbol] ; if the selected consonant is [symbol] , the leftward gesture direction changes it to [symbol] , and the upward gesture direction changes it to [symbol] ; if the selected consonant is [symbol] , the leftward gesture direction changes it to [symbol] , and the upward gesture direction does not change the selected consonant; if the selected consonant is ∘, the leftward gesture direction does not change the selected consonant, and the upward gesture direction changes it to [symbol] ; if the selected consonant is [symbol] , the leftward gesture direction changes it to [symbol] , and the upward gesture direction changes it to [symbol] ; if the selected consonant is [symbol] or [symbol] , the leftward or the upward gesture direction does not change the selected consonant. FIG. 8 shows the consonant candidates associated with leftward and upward gesture directions as described above.

FIG. 9 illustrates an example of changing the selected consonant 901 with leftward gesture direction in a preferred embodiment. As a user starts a gesture on the displayed consonant candidate [symbol] 901, and continues the gesture to the leftward 902, the selected consonant [symbol] is changed to [symbol] .

In another preferred embodiment, the gesture direction 903 may be used for changing the newly selected consonant [symbol] back to the previous [symbol] . As the gesture returns to the displayed consonant candidate area 900 via the rightward gesture direction 903, and the gesture direction 902 is again invoked, the newly selected [symbol] is changed back to [symbol] . In such embodiment, the selection of a vowel may need to be delayed until the gesture is returned to the displayed consonant candidate area 900 in order to distinguish the rightward gesture direction 903 from the rightward gesture direction used for selecting a vowel.

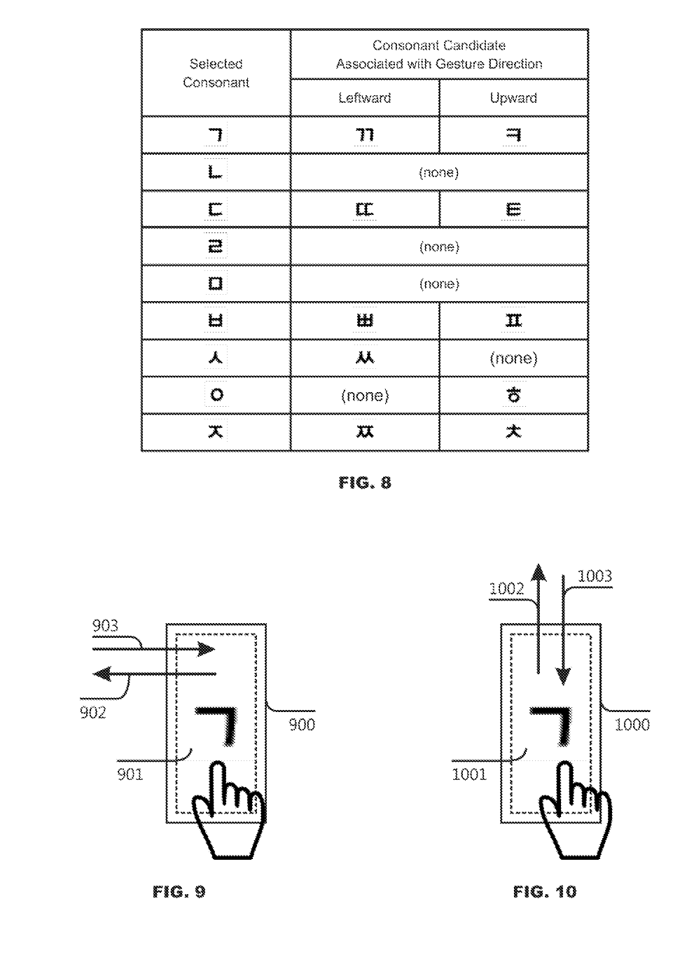

FIG. 10 illustrates an example of changing the selected consonant 1001 with upward gesture direction in a preferred embodiment. As a user starts a gesture on the displayed consonant candidate [symbol] 1001, and continues the gesture to the upward 1002, the selected consonant [symbol] is changed to [symbol] .

In another preferred embodiment, the gesture direction 1003 may be used for changing the newly selected consonant [symbol] back to the previous [symbol] . As the gesture returns to the displayed consonant candidate area 1000 via the downward gesture direction 1003, and the gesture direction 1002 is again invoked, the newly selected [symbol] is changed back to [symbol] . In such embodiment, the selection of a vowel may need to be delayed until the gesture is returned to the displayed consonant candidate area 1000 in order to distinguish the downward gesture direction 1003 from the downward gesture direction used for selecting a vowel.

In a preferred embodiment, if the direction of the gesture is identified as rightward in step 700 of FIG. 7, the processing logic selects 1st Vowel Candidate Set in step 702; if the direction is identified as downward, the processing logic selects 2nd Vowel Candidate Set in step 703. If the gesture is ended, the processing logic executes step 707 to finish the transitional Korean character composition and handle the acquired character elements, as described further below.

In step 704, a vowel is selected from the chosen vowel candidate set based on the distance from the selected consonant. For 1st Vowel Candidate Set wherein the vowel candidate set is selected with rightward gesture direction, the distance is measured horizontally; for 2nd Vowel Candidate Set wherein the vowel candidate set is selected with downward gesture direction, the distance is measured vertically.

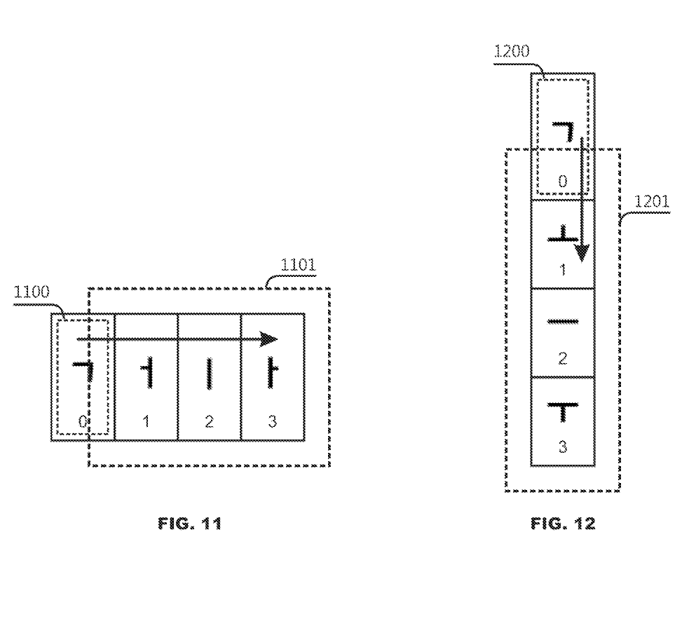

FIG. 11 illustrates how a distance is measured for selecting a vowel from the 1st Vowel Candidate Set. For the selected consonant 1100, the distance increases as the rightward gesture moves horizontally away from the selected consonant 1100. If the direction of the gesture is changed to leftward, the distance decreases as the leftward gesture moves closely to the selected consonant 1100.

FIG. 12 illustrates how a distance is measured for selecting a vowel from the 2nd Vowel Candidate Set. For the selected consonant 1200, the distance increases as the downward gesture moves vertically away from the selected consonant 1200. If the direction of the gesture is changed to upward, the distance decreases as the upward gesture moves closely to the selected consonant 1200.

The four directions of a gesture are classified as either vertical or horizontal orientation; upward and downward directions are classified as vertical orientation; leftward and rightward directions are classified as horizontal orientation.

In step 705 of FIG. 7, the gesture is kept monitored, and when the orientation of the gesture direction is changed, the processing logic executes step 706, as further described below. Otherwise, the processing logic repeats the procedures starting from step 704.

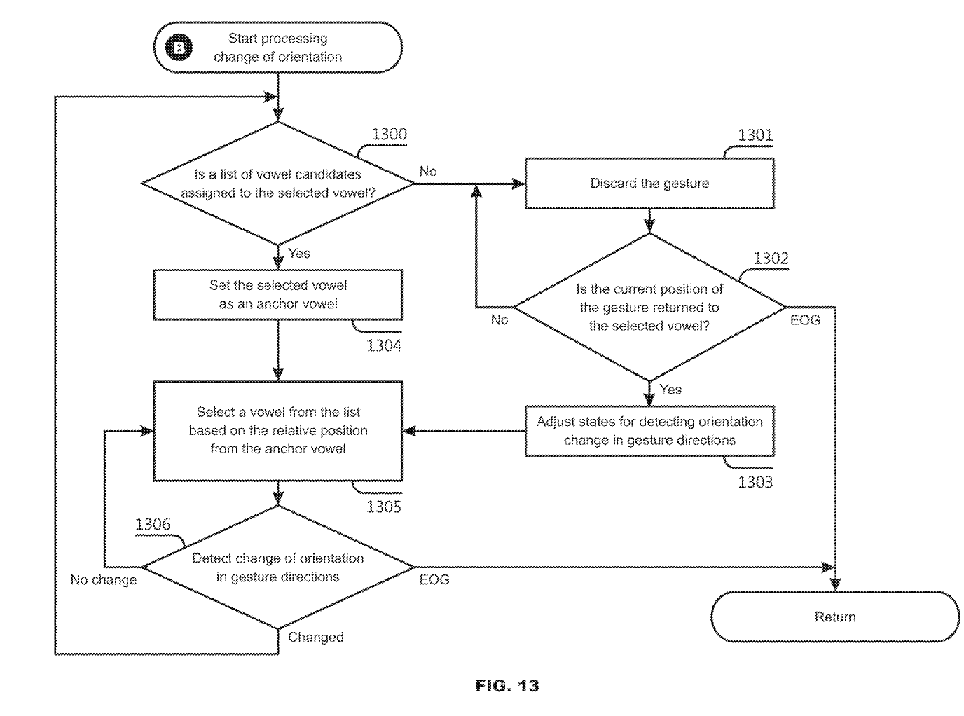

FIG. 13 is a flow chart describing the process of handling the change of orientation in gesture directions as illustrated as step 706 in FIG. 7.

When the orientation of the gesture direction is changed, the processing logic checks the selected vowel for its assigned vowel candidates in step 1300. If the selected vowel has one or more assigned vowel candidates, the processing logic marks the selected vowel as an anchor vowel in step 1304.

A new vowel is chosen from the assigned vowel candidates based on the relative distance from the anchor vowel, and the newly chosen vowel replaces the currently selected vowel in step 1305. In step 1306, the gesture is kept monitored, and if the orientation of the gesture direction is again changed, the processing logic repeats the procedures starting from step 1300; if the orientation of the gesture direction is not changed, the processing logic repeats the procedures starting from step 1305.

In step 1300, if the selected vowel does not have any assigned vowel candidate, the gesture is ignore in step 1301; and the processing logic waits until the position of the gesture returns to the selected vowel in step 1302. When the position of the gesture returns to the selected vowel, various states are adjusted in step 1303 to prevent the discarded gesture in step 1301 from affecting the processing logic when it repeats the procedures starting from step 1305.

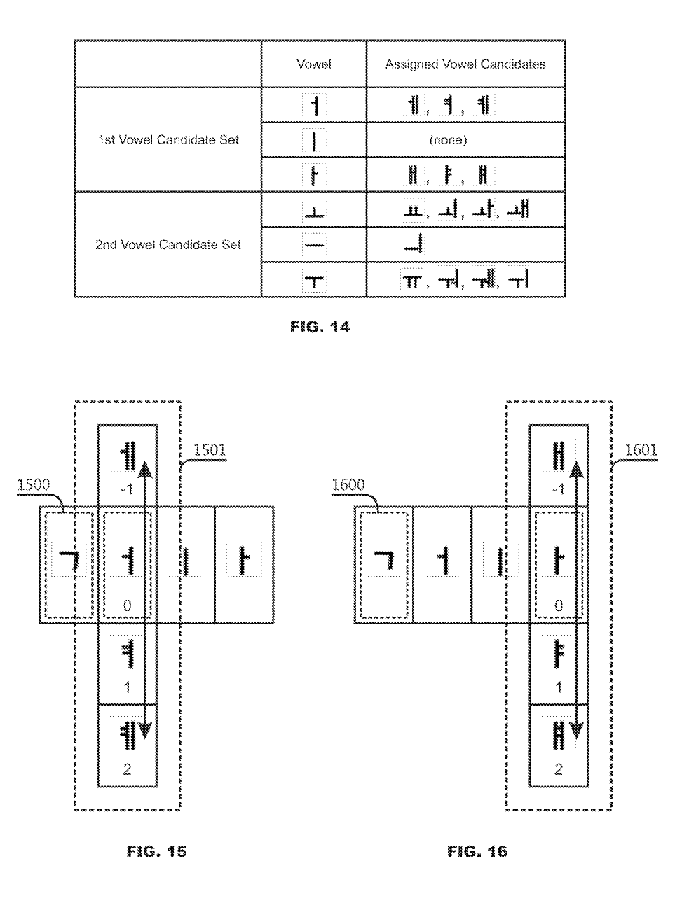

FIG. 14 shows assigned vowel candidate lists for each of the vowels in 1st and 2nd Vowel Candidate Sets. If the vowel is [symbol] , the list comprises [symbol] and [symbol] ; if the vowel is [symbol] , the list comprises [symbol] and [symbol] ; if the vowel is [symbol] , the list comprises [symbol] and [symbol] ; if the vowel is —, the list comprises [symbol] ; if the vowel is [symbol] , the list comprises [symbol] and [symbol] .

The relative distance used for choosing a new vowel from the list of assigned vowel candidates is determined from the position values aligned to the orientation of the changed gesture direction; if the orientation is changed from vertical to horizontal, rightward direction increases and leftward direction decreases the relative distance from the anchor vowel; if the orientation is changed from horizontal to vertical, downward direction increases and upward direction decreases the relative distance from the anchor vowel.

FIG. 15 shows the placement of the vowel candidates 1501 assigned to the vowel [symbol] in a preferred embodiment. A user starts a gesture at 1500, and continues the gesture rightward until the vowel [symbol] is selected. The orientation of the gesture direction is then changed; the vowel [symbol] becomes an anchor vowel; the preferred embodiment selects the vowel candidates, [symbol] and [symbol] . The user selects a new vowel by continuing the gesture upward or downward.

FIG. 16 is essentially the same as FIG. 15 except the anchor vowel is [symbol] and the assigned vowel candidates are [symbol] and [symbol] . In FIG. 16, a user starts a gesture at 1600 and 1601 shows the placement of the assigned vowel candidates.

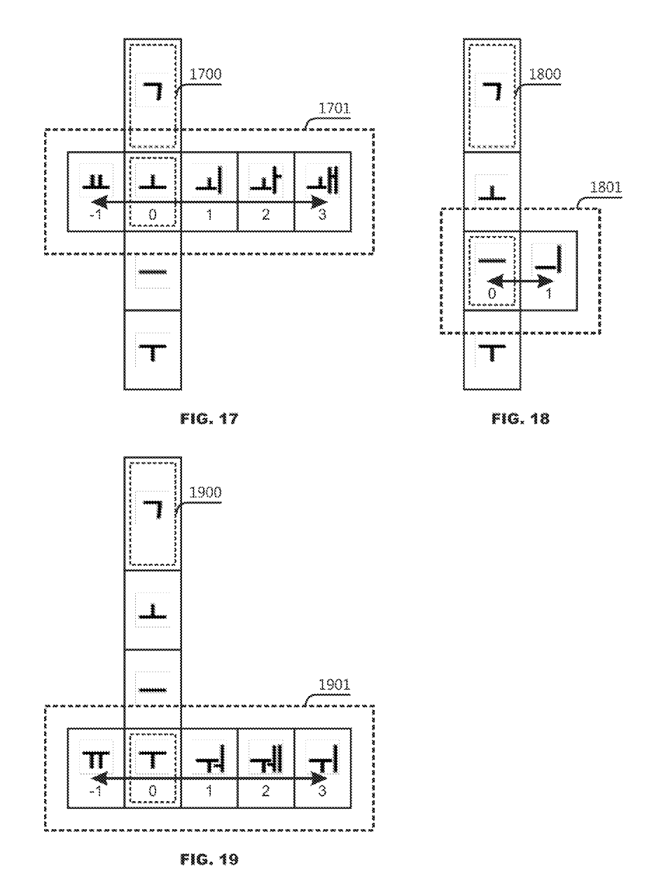

FIG. 17 shows the placement of the vowel candidates 1701 assigned to the vowel [symbol] in a preferred embodiment. A user starts a gesture at 1700, and continues the gesture downward until the vowel [symbol] is selected. The orientation of the gesture direction is then changed; the vowel [symbol] becomes an anchor vowel; the preferred embodiment selects the vowel candidates, [symbol] and [symbol] . The user selects a new vowel by continuing the gesture leftward or rightward.

FIG. 18 is essentially the same as FIG. 17 except the anchor vowel is — and the assigned vowel candidate is [symbol] . In FIG. 18, a user starts a gesture at 1800 and 1801 shows the placement of the assigned vowel candidate.

FIG. 19 is also essentially the same as FIG. 17 except the anchor vowel is [symbol] and the assigned vowel candidates are [symbol] and [symbol] . In FIG. 19, a user starts a gesture at 1900 and 1901 shows the placement of the assigned vowel candidates.

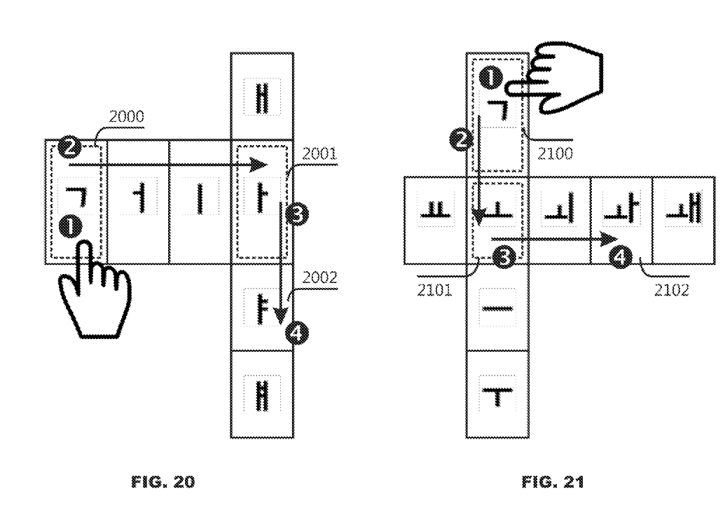

FIG. 20 illustrates how a consonant [symbol] and a vowel [symbol] are selected for composing a Korean character [symbol] in a preferred embodiment. A user starts a gesture at 2000 where a consonant candidate [symbol] is placed, and continues the gesture rightward until the vowel [symbol] is selected at 2001. The orientation of the gesture direction is then changed to vertical; the vowel [symbol] becomes an anchor vowel; the preferred embodiment selects the vowel candidates, [symbol] and [symbol] . The user selects the vowel [symbol] by continuing the gesture downward until the vertical distance from the anchor vowel 2001 is increased enough to select [symbol] at 2002.

FIG. 21 illustrates how a consonant [symbol] and a vowel [symbol] are selected for composing a Korean character [symbol] in a preferred embodiment. A user starts a gesture at 2100 where a consonant candidate [symbol] is placed, and continues the gesture downward until the vowel [symbol] is selected at 2101. The orientation of the gesture direction is then changed to horizontal; the vowel [symbol] becomes an anchor vowel; the preferred embodiment selects the vowel candidates, [symbol] and [symbol] . The user selects the vowel [symbol] by continuing the gesture rightward until the horizontal distance from the anchor vowel 2101 is increased enough to select [symbol] at 2102.

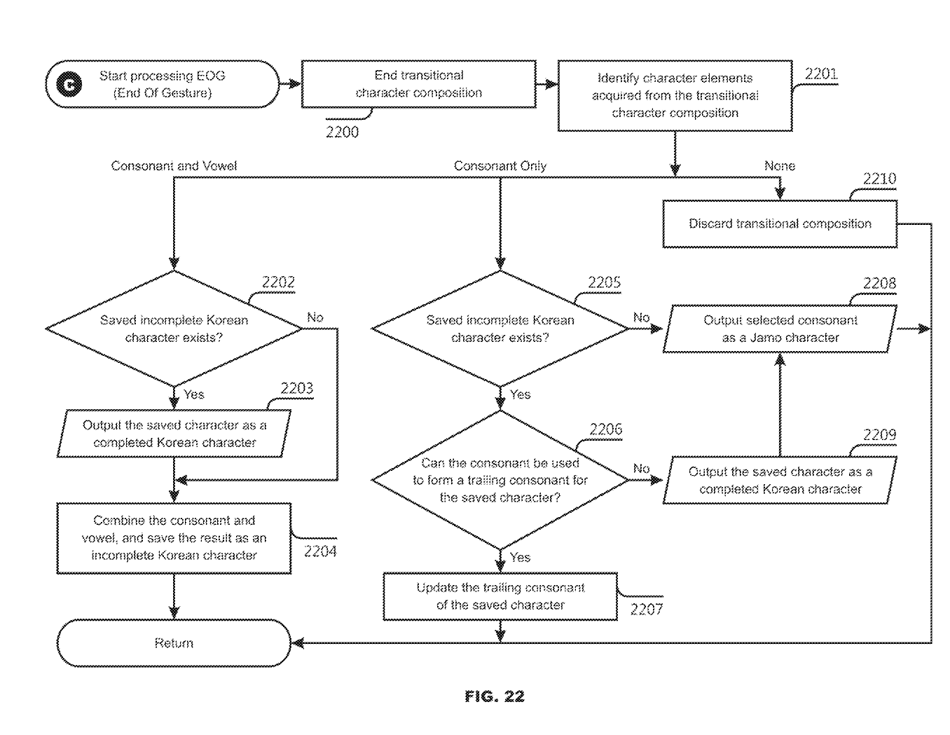

FIG. 22 is a flow chart describing the process of handling the end of a gesture as illustrated as step 707 in FIG. 7.

When the user ends a gesture, the processing logic also ends the transitional Korean character composition in step 2200, and identifies the character elements acquired from the transitional Korean character composition in step 2201.

If a consonant and a vowel are selected, the processing logic checks for a previously saved incomplete Korean character in step 2202; if such character exists, the processing logic outputs the character in step 2203 as a completed Korean character. In step 2204, the processing logic combines the selected consonant and vowel, and forms a Korean character. The newly formed Korean character is saved as an incomplete Korean character since its trailing consonant is not yet determined.

If only a consonant is selected, the processing logic checks for a previously saved incomplete Korean character in step 2205. If such character is found, the processing logic checks for a possibility of updating the trailing consonant of the saved character with the selected consonant in step 2206 in accordance with the Korean grammar; otherwise, the selected consonant is outputted in step 2208 as a Jamo character.

If only a consonant is selected and it cannot be used as a trailing consonant for the saved incomplete Korean character in any way, the processing logic outputs the saved character as a completed Korean character in step 2209, and also outputs the selected consonant as a Jamo character in step 2208.

In step 2207, the processing logic updates the trailing consonant of the saved incomplete Korean character with the selected consonant; if the saved character does not have a trailing consonant, the selected consonant becomes the trailing consonant of the saved character; otherwise, the selected consonant is combined with the existing trailing consonant of the saved character.

If neither a consonant nor a vowel is selected, the transitional Korean character composition is discarded in step 2210.

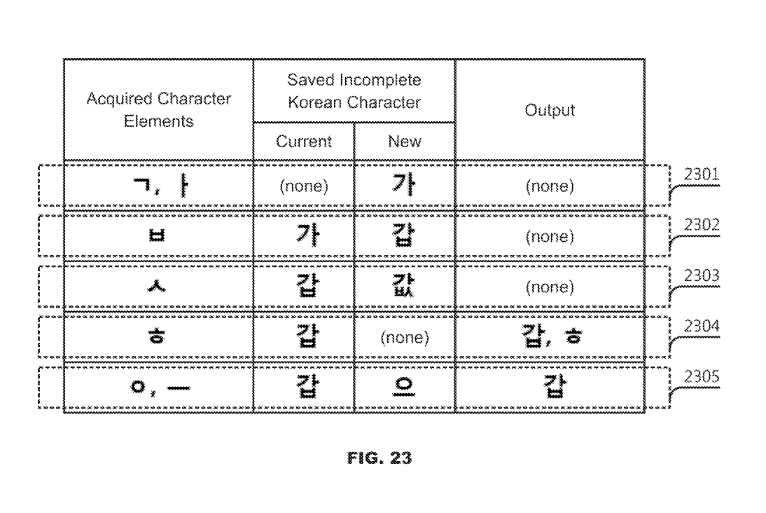

FIG. 23 shows examples of transitional Korean character compositions and their resulted outputs in a preferred embodiment. In the example 2301, a consonant [symbol] and a vowel [symbol] are acquired from the transitional composition; the preferred embodiment combines the elements and forms a Korean character [symbol] ; as the preferred embodiment does not have a saved incomplete Korean character, the combined character [symbol] is saved as a new incomplete Korean character.

In the example 2302, only a consonant [symbol] is acquired from the transitional composition; as the preferred embodiment has a saved incomplete Korean character [symbol] is combined with [symbol] as a trailing consonant and [symbol] becomes a new Korean character [symbol] ; the newly composed Korean character [symbol] replaces previously saved incomplete Korean character.

In the example 2303, only a consonant [symbol] is acquired from the transitional composition; as the preferred embodiment has a saved incomplete Korean character [symbol] is combined with [symbol] as a part of the trailing consonant and [symbol] becomes a new Korean character [symbol] ; the newly composed Korean character [symbol] replaces previously saved incomplete Korean character.

In the example 2304, only a consonant [symbol] is acquired from the transitional composition; the preferred embodiment has a saved incomplete Korean character [symbol] , but [symbol] cannot form a new trailing consonant with the existing trailing consonant [symbol] according to the modern Korean grammar; the preferred embodiment outputs [symbol] as a completed Korean character; [symbol] is also outputted as a Jamo character.

In the example 2305, a consonant ∘ and a vowel — are acquired from the transitional composition; the preferred embodiment combines the elements and forms a Korean character [symbol] ; the preferred embodiment outputs the previously saved incomplete Korean character [symbol] as a completed Korean character; the newly composed Korean character [symbol] is saved as an incomplete Korean character.

The saved incomplete Korean character is also outputted when a character unrelated to Korean character composition is inputted, or the character input mode of the preferred embodiment is no longer set to Korean.

While the preferred embodiment of the present invention has been illustrated and described, as noted above, many changes can be made without departing from the spirit and scope of the present invention. Accordingly, the scope of the present invention is not limited by the disclosure of the preferred embodiment.

What is claimed is:

1. A method for input of Korean characters into an electronic device having a display and a gesture input component, the gesture input component having a capability of reporting the position history of a gesture, comprising:
displaying consonant candidates for composing a Korean character;
receiving gesture data of a gesture from the gesture input component, wherein the gesture data includes movement coordinates of the gesture as the gesture input component detects starting and ending of the gesture;
selecting a consonant and an optional vowel based on the gesture data;
composing a Korean character based on the selected character elements; and
outputting a Korean character and/or a Jamo character.

2. The method of claim 1, wherein the consonant candidates are chosen from the starting consonant variants of a Korean character.

3. The method of claim 1, wherein the locations of the displayed consonant candidates indicate where a gesture can be used for composing a Korean character.

4. The method of claim 1, wherein a consonant is selected from the displayed consonant candidates based on the starting position of the gesture.

5. The method of claim 1, further comprising changing the selected consonant when the gesture is continued leftward or upward while selecting a consonant from the displayed consonant candidates.

6. The method of claim 1, wherein a vowel is selected when the gesture is continued rightward or downward after selecting a consonant.

7. The method of claim 6, wherein a vowel is selected from a set of vowel candidates associated with the gesture direction based on the relative distance measured from the selected consonant.

8. The method of claim 1, further comprising selecting a vowel from a different set of vowel candidates when the orientation of the gesture direction is changed.

9. The method of claim 1, wherein when a consonant and a vowel are selected, a Korean character is composed based on the selected consonant and vowel, and saved as an incomplete Korean character after outputting the previously saved incomplete Korean character as a completed Korean character.

10. The method of claim 1, wherein when only a consonant is selected, the selected consonant updates the trailing consonant of the saved incomplete Korean character.

11. The method of claim 10, wherein when the selected consonant cannot update the trailing consonant of the saved incomplete Korean character, the saved incomplete Korean character is outputted as a completed Korean character and the selected consonant is also outputted as a Jamo character.

12. An apparatus comprising:
a display for indicating locations of consonant candidates where a gesture can be used for composing a Korean character;
a gesture input component for acquiring gesture data of a gesture, wherein the gesture data includes movement coordinates of the gesture as the gesture input component detects starting and ending of the gesture;
a memory for storing character composition states; and
a processor coupled to the display, the gesture input component, and the memory, the processor is configured to:
receive gesture data from the gesture input component;
select a consonant and an optional vowel based on the gesture data;
compose a Korean character based on the selected character elements; and
output a Korean character and/or a Jamo character.
